(19) United States
(12) Patent Application Publication
(10) Pub. No.: US 2012/0025426 A1
(43) Pub. Date: Feb. 2, 2012

(54) METHOD AND SYSTEM FOR THERMAL IMPRINT LITHOGRAPHY

(75) Inventors: David Kuo, Palo Alto, CA (US); Justin Hwu, Fremont, CA (US); Gennady Gauzner, San Jose, CA (US); Kim Yang Lee, Fremont, CA (US); Dieter Weller, San Jose, CA (US)

(73) Assignee: SEAGATE TECHNOLOGY LLC, Scotts Valley, CA (US)

(21) Appl. No.: 12/847,964

(22) Filed: Jul. 30, 2010

(51) Int. Cl. B29C 59/02

(52) U.S. Cl. 264/331.11; 264/319; 425/470

(57) ABSTRACT

A method and apparatus of thermal imprint lithography includes moving an imprinter against a surface to be imprinted, supplying energy to a layer of heating material, and forming features in the surface to be imprinted. The imprinter comprises a main body and the layer of heating material under the main body. In an embodiment the layer of heating material is electrically heated. In alternate embodiments, the layer of heating material is optically heated.

### FIELD

Embodiments according to the present invention generally relate to thermal imprint lithography.

### BACKGROUND

Micro-fabrication involves the fabrication of very small structures, for example structures having features on the order of micro-meters or smaller. Lithography is a micro-fabrication technique used to create ultra-fine (sub-25 nm) patterns in thin film on a substrate. During lithography, a mold having at least one protruding feature is pressed into the thin film. The protruding feature in the mold creates a recess in the thin film, thus creating an image of the mold. The thin film retains the image as the mold is removed. The mold may be used to imprint multiple thin films on different substrates.

### BRIEF DESCRIPTION OF THE DRAWINGS

The present invention is illustrated by way of example, and not by way of limitation, in the figures of the accompanying drawings.

FIG. 1 is a cross-sectional view of thin film layers at an early stage of manufacture, and further showing an imprinter according to an embodiment of the present invention.

FIG. 2 is a cross-sectional view of the imprinter forming features in the thin film layers of FIG. 1 by electrically heating a thin heat layer according to an embodiment of the present invention.

FIG. 3 is a cross-sectional view of the imprinter and the thin film layers after imprinting and separation, according to an embodiment.

FIG. 4 is a cross-sectional view of an imprinter forming features in a thin film layer by optically heating an optical absorbing layer according to an embodiment of the present invention.

FIG. 5 is a cross-sectional view of an imprinter forming features in a thin film layer by optically heating an optical absorbing resist layer according to an embodiment of the present invention.

FIG. 6 is a flow diagram of a method of thermal imprint lithography according to an embodiment of the present invention.

FIG. 7 is a plan view of a disc drive data storage device.

FIG. 8 is a cross-sectional view of a perpendicular magnetic recording medium that may be used for the disc drive storage device (FIG. 7), according to an embodiment.

FIG. 9 is a cross-sectional view of the perpendicular magnetic recording medium (FIG. 8) with a head unit, according to an embodiment.

### DETAILED DESCRIPTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

For expository purposes, the term “horizontal” as used herein is defined as a plane parallel to the plane or surface of a substrate, regardless of its orientation. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

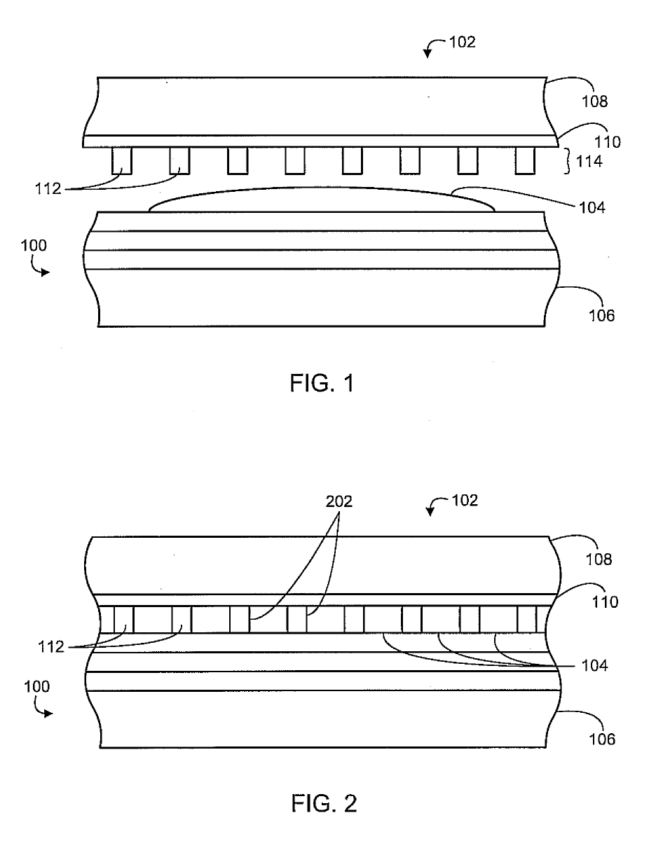

FIG. 1 is a simplified cross-sectional view of thin film layers 100 at an early stage of manufacture, and further showing an imprinter 102 according to an embodiment of the present invention. At this stage, a resist layer 104 has been formed over a substrate 106 in preparation for thermal imprint lithography. In the current embodiment, the resist layer 104 is a thermal plastic, for example polymethyl methacrylate (PMMA), polystyrene (PS), or styrene acrylonitrile (SAN).

The imprinter 102 comprises a main body 108, a layer of heating material 110 under the main body 108, and an imprinting layer 112 under the layer of heating material 110. Thus, the layer of heating material 110 is between the main body 108 and the imprinting layer 112.

The main body 108 is comprised of a rigid material, for example Ni or Ni alloy. The layer of heating material 110 is a thin layer of an electrical heating material, for example an electrical resistance sheet material that converts electrical energy into thermal energy. The layer of heating material 110 may have electrical connectors or terminals (not shown) at opposite ends.

The imprinting layer 112 is comprised of a mechanically hard material, for example Ni or Ni alloy. In addition, the imprinting layer 112 includes a surface with a pattern 114 formed therein. The pattern 114 is a negative image of a pattern of sub-micron or nano-dimensioned features, for example lateral dimensions of about 60 nm and heights of about 40 nm, to be imprinted in the resist layer 104. The pattern 114 can be densely packed, for example half pitch from 10 nm-100 nm or isolated features 10 nm-100 nm features with a few ums pitch between nano features. In the current embodiment, the pattern 114 is formed using conventional optical lithographic techniques. The imprinting layer 112 may be provided with a thin layer of an anti-sticking or release agent (not shown), for example a fluorinated polyether compound such as for example Zdol®, available from Ausimont, Thorofare, N.J. or a fluorine-based polymer with silane end group (self-assemble mono-layer structure).

FIG. 2 is a simplified cross-sectional view of the imprinter 102 during formation of features 202 in the thin film layers 200, according to an embodiment of the present invention. The imprinter 102 and the perpendicular magnetic recording medium 100 are forcefully moved into contact, for example at a pressure of ˜0.2 to ˜10.0 MPa. An electric current is supplied from an electrical power supply (not shown) to the layer of heating material 110. The layer of heating material 110 may be an electrical resistance heating material that quickly heats in as short an interval as practicable, for example ˜2 to ˜10 seconds, to a temperature above the glass transition temperature T_{g}, for example at least about 180° C., of the resist layer 104, causing the resist layer 104 to reflow.

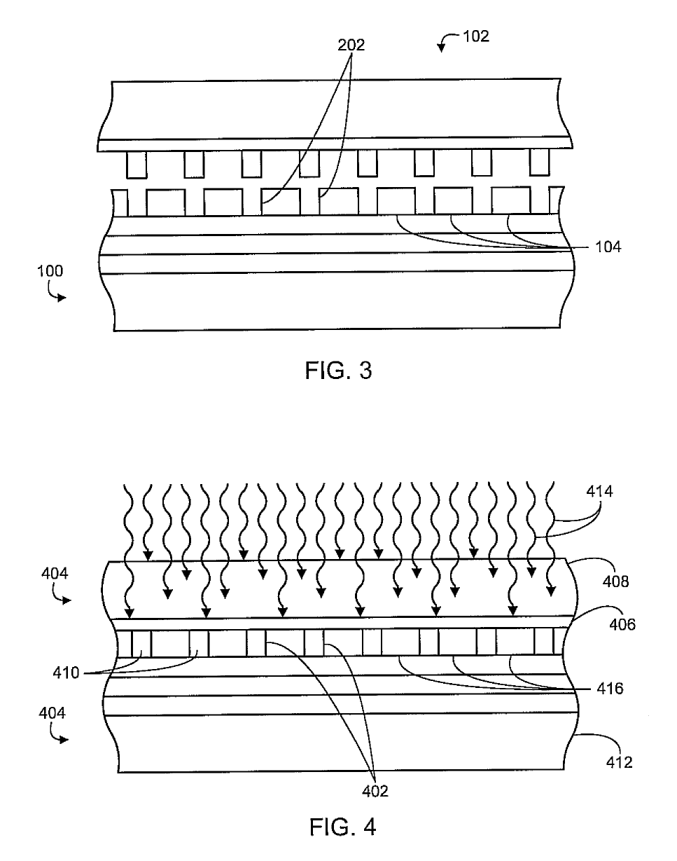

The heating material 110 selectively heats the imprinting layer 112 and the resist layer 104, without substantially altering the temperature of the substrate 106 and the main body 108. Thus, heat is confined to the materials in interfacial contact (in the current embodiment, the resist layer 104, the heating material 110, and the imprinting layer 112) and their vicinity. After an appropriate interval, for example less than about 10 seconds, the supply of electrical power to the heating material 110 is terminated. Before separation (see FIG. 3), the heating material 110, the imprinting layer 112, and the resist layer 104 are allowed to cool to a temperature below the glass transition temperature T_{g} of the resist layer 104, for example about 130-140° C. for PMAA.

In the current embodiment, the relatively large main body 108 and substrate 106 are not heated or cooled. However, in alternate embodiments the thin film layers 100 and the imprinter 102 may be pre-heated and maintained at a preselected elevated temperature prior to heating the heating material 110, thus reducing the processing interval. For example, the imprinter 102 may be pre-heated to and maintained at an elevated temperature close to the glass transition temperature T_{g} of the resist layer 104, ˜105° C. for PMMA. Therefore, the heating material 110 quickly heats up to the glass transition temperature T_{g} of the resist layer 104 during formation of the features 202.

FIG. 3 is a simplified cross-sectional view of the imprinter 102 and the thin film layers 100 after imprinting and separation, according to an embodiment of the present invention. The imprinter 102 and the thin film layers 100 have been separated after cooling. Thus, the resist layer 104 of the thin film layers 100 has been imprinted with the features 202.

FIG. 4 is a simplified cross-sectional view of an imprinter 400 during formation of features 402 in thin film layers 404 at an early stage of manufacture, according to an alternate embodiment. Instead of electrically heating the heating material 112 (FIG. 2), a heating material 406 is an optically absorbing layer between a main body 408 and an imprinting layer 410.

The main body 408 may be transparent and, in the current embodiment, comprised of infra-red (IR) and visible light transmissive materials, for example quartz, Pyrex®, etc. The heating material 406 is comprised of an optically heated material that absorbs radiant/photonic energy, for example IR or visible light, and thus is selectively heated. The heating material 406 may comprise a thermoplastic polymer material that is inherently radiation absorbing, and/or the heating material 406 may include at least one radiation absorbing material for facilitating heating, for example a dye may be used.

A light source (not shown) delivers energy 414 to the heating material 406. The energy 414 passes through the main body 408 and selectively heats the heating material 406, without significantly heating the substrate 412 or the main body 408. The temperature of the heating material 406 and the time to reach the appropriate temperature are controlled by regulating the intensity and wavelength of the energy 414.

As in the previous embodiment, heating of the heating material 406 may stop when the temperature rises above the glass transition temperature T_{g} of a thermoplastic resist material 416. The heating material 406, the imprinting layer 410, and the thermoplastic resist material 416 are then allowed to cool down to a temperature below the glass transition temperature T_{g} of the thermoplastic resist material 416. The imprinter 400 and the thin film layers 404 are separated (not shown), leaving the thin film layers 404 ready for further processing (not shown).

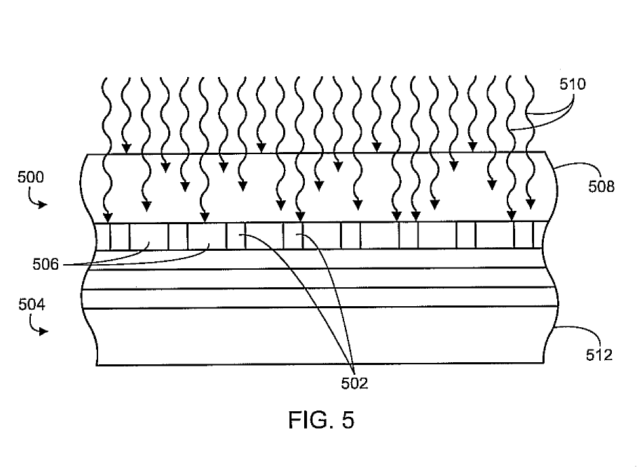

FIG. 5 is a simplified cross-sectional view of an imprinter 500 during formation of features 502 in thin film layers 504 at an early stage of manufacture, according to an alternate embodiment of the present invention. In the present embodiment, there is no separate heating material (110 in FIGS. 2 and 406 in FIG. 4). Instead, an optically heated resist layer 506 is between a light transmissive main body 508 and the thin film layers 504.

The optically heated resist layer 506 may be a thermoplastic resist layer over a substrate 512 that is inherently radiation absorbing and/or includes at least one radiation absorbing material. A light source (not shown) delivers energy 510 to the optically heated resist layer 506. The energy 510 passes through the light transmissive main body, and selectively heats the optically heated resist layer 506, without significantly heating the substrate 512 or the light transmissive main body 508.

As in previous embodiments, heating of the optically heated resist layer 506 stops when the temperature of the optically heated resist layer 506 rises above the glass transition temperature T_{g}. The optically heated resist layer 506 is then allowed to cool down to a temperature below the glass transition temperature T_{g}. The imprinter 500 and the thin film layers 504 are separated (not shown), leaving the thin film layers 504 with an imprinted resist layer (not shown), ready for further processing (not shown).

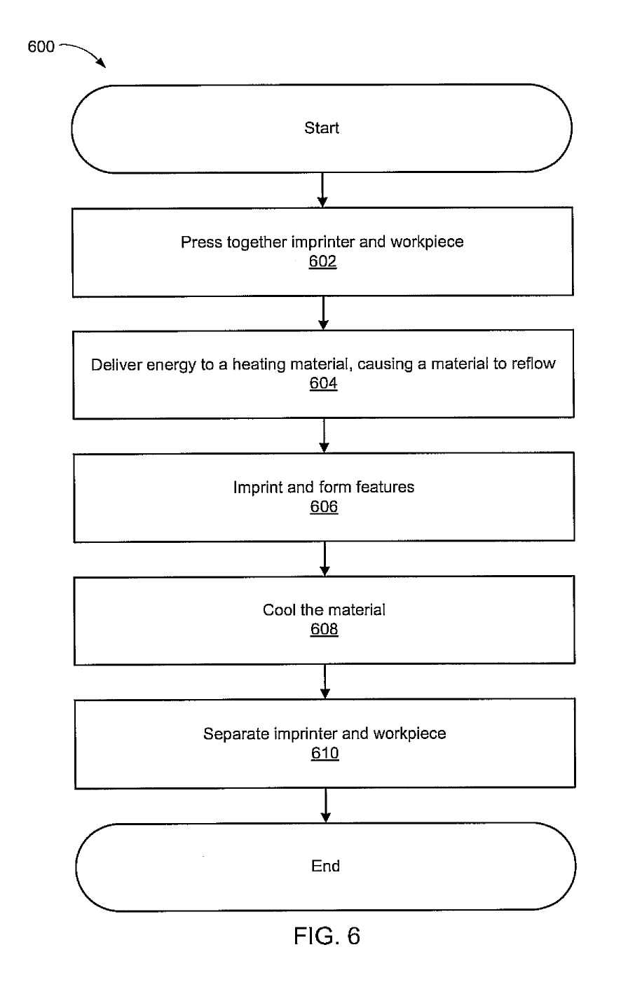

FIG. 6 depicts a flowchart 600 of an exemplary method of thermal imprint lithography according to an embodiment of the present invention. Although specific steps are disclosed in the flowchart, such steps are exemplary. That is, embodiments of the present invention are well-suited to performing various other steps or variations of the steps recited in the flowchart.

In block 602, an imprinter and a workpiece are pressed together. For example, in FIG. 2 an imprinter comprises a main body, a layer of heating material under the main body, and an imprinting layer. The imprinter is moved against a surface of the workpiece to be imprinted. The workpiece is thin film layers, at an early stage of manufacture, comprising a substrate and a resist layer.

In block 604, energy is supplied to the layer of heating material, causing a layer of material between the main body and the workpiece to heat and reflow. For example, in the embodiment of FIG. 2 the layer of heating material is an electrical heating sheet and the material to reflow is a thermal plastic resist layer. Supplying electrical energy to the electrical heating sheet heats the electrical heating sheet, causing the thermal plastic resist layer to reflow, without substantially heating the imprinter and the main body.

In another example, in the alternate embodiments of FIGS. 4 and 5, the layer of heating material is an optically absorbing layer. Energy is supplied to the optically absorbing layer using a light source to deliver energy. In the embodiment of FIG. 4, energy from the light source causes an optically absorbing layer between the main body and the workpiece to heat. However, in the embodiment of FIG. 5, there is no separate optically absorbing layer. Instead, the resist layer is also the optically absorbing layer. Thus, the layer of heating material in FIG. 5 is an optically absorbing resist layer over a substrate. Light energy is delivered to the optically absorbing resist layer, causing it to heat.

In a block 606, the heating causes the workpiece to be imprinted by allowing the imprinting layer to form features in the thermal plastic resist layer. In a block 608, the layer of material between the main body and the workpiece is cooled to a temperature where viscosity of the material between the main body and the workpiece is high, forming features in the surface of the workpiece. In a block 610, the imprinter and the workpiece are separated. For example, in FIG. 3 an imprinter and thin film layers have been separated after cooling of the resist layer. Features have been formed in the resist layer, and the thin film layers are ready for further processing.

Magnetic storage media are widely used in various applications, particularly in the computer industry for data storage and retrieval applications, as well as for storage of audio and video signals. Perpendicular magnetic recording media, for example hard disc drive storage devices, include recording media with a perpendicular anisotropy in the magnetic layer. In perpendicular magnetic recording media, residual magnetization is formed in a direction perpendicular to the surface of the magnetic medium, typically by a layer of a magnetic material on a substrate.

A perpendicular recording disc drive head typically includes a trailing write pole, and a leading return or opposing pole magnetically coupled to the write pole. In addition, an electrically conductive magnetizing coil surrounds the yoke of the write pole. During operation, the recording head flies above the magnetic recording medium by a distance referred to as the fly height. To write to the magnetic recording medium, the magnetic recording medium is moved past the recording head so that the recording head follows the tracks of the magnetic recording medium, with the magnetic recording medium first passing under the return pole and then passing under the write pole. Current is passed through the coil to create magnetic flux within the write pole. The magnetic flux passes from the write pole tip, through the hard magnetic recording track, into the soft underlayer, and across to the return pole. In addition to providing a return path for the magnetic flux, the soft underlayer produces magnetic charge images of the magnetic recording layer, increasing the magnetic flux and increasing the playback signal. The current can be reversed, thereby reversing the magnetic field and reorienting the magnetic dipoles.

The perpendicular recording medium is a continuous layer of discrete, contiguous magnetic crystals or domains. Within the continuous magnetic layer, discrete information is stored in individual bits. The individual bits are magnetically oriented positively or negatively, to store binary information. The number of individual bits on the recording medium is a function of the areal density. As areal densities increase, the amount of information stored on the recording medium also increases. Manufacturers strive to satisfy the ever-increasing consumer demand for higher capacity hard drives by increasing the areal density.

High density perpendicular recording media use carefully balanced magnetic properties. These carefully balanced magnetic properties include sufficiently high anisotropy (perpendicular magnetic orientation) to ensure thermal stability, resist erasure, and function effectively with modern disc drive head designs; and grain-to-grain uniformity of magnetic properties sufficient to maintain thermal stability and minimum switching field distribution (SFD).

As recording densities increase, smaller grain structures help to maintain the number of magnetic particles in a bit at a similar value. Smaller grain structures are easier to erase, requiring higher anisotropy to maintain thermal stability, and making writability worse. Further, when individual storage bits within magnetic layers of magnetic recording media are reduced in size, they store less energy making it easier for the bits to lose information. Also, as individual weaker bits are placed closer together, it is easier for continuous read/write processes and operating environments to create interference within and between the bits. This interference disrupts the read/write operations, resulting in data loss.

The magnetic layers are designed as an ordered array of uniform islands, each island storing an individual bit. This is referred to as bit patterned media. By eliminating the continuous magnetic layer and restricting the bits to discrete magnetic islands, interference is reduced and areal densities are increased. However, high areal density bit patterned media (e.g., >500 Gbpsi) demands high anisotropy of the magnetic material in the islands.

Methods and media structures are described herein, which embodiments of the present invention as described above, optimize anisotropy for bit patterned magnetic recording media. It is appreciated that magnetic recording media as discussed herein may be utilized with a variety of systems including disc drive memory systems, etc.

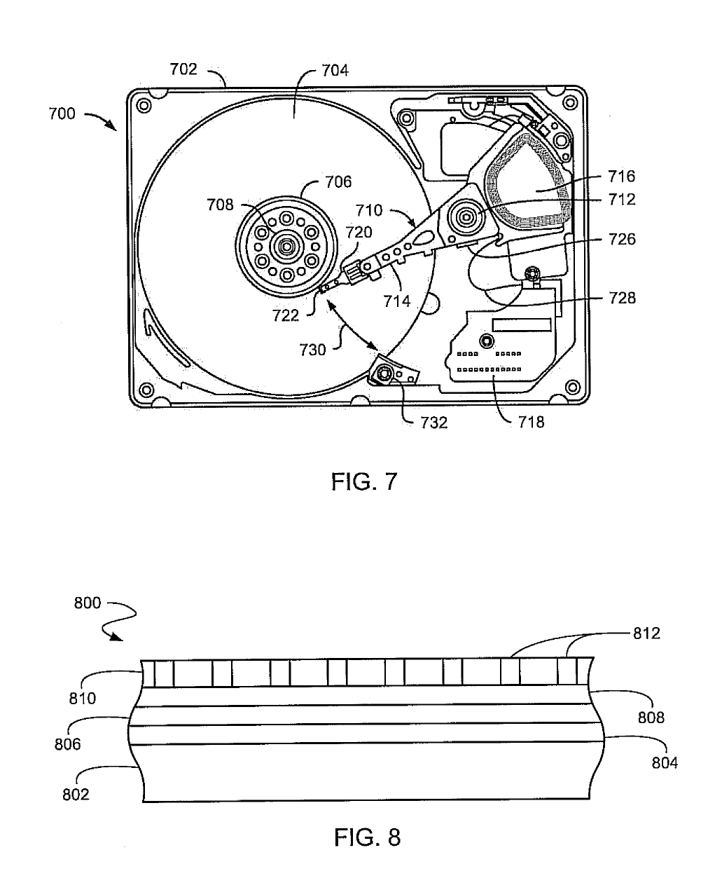

FIG. 7 is a data storage device in which embodiments of the present invention can be implemented to form bit-patterned media. FIG. 7 is a plan view of a disc drive 700. The disc drive 700 generally includes a base plate 702 and a cover (not shown) that may be disposed on the base plate 702 to define an enclosed housing for various disc drive components. The disc drive 700 includes one or more data storage discs 704 of computer-readable data storage media. Typically, both of the major surfaces of each data storage disc 704 include a plurality of concentrically disposed tracks for data storage purposes. Each data storage disc 704 is mounted on a hub or spindle 706, which in turn is rotatably interconnected with the base plate 702 and/or cover. Multiple data storage discs 704 are typically mounted in vertically spaced and parallel relation on the spindle 706. A spindle motor 708 rotates the data storage discs 704 at an appropriate rate.

The disc drive 700 also includes an actuator arm assembly 710 that pivots about a pivot bearing 712, which in turn is rotatably supported by the base plate 702 and/or cover. The actuator arm assembly 710 includes one or more individual rigid actuator arms 714 that extend out from near the pivot bearing 712. Multiple actuator arms 714 are typically disposed in vertically spaced relation, with one actuator arm 714 being provided for each major data storage surface of each data storage disc 704 of the disc drive 700. Other types of actuator arm assembly configurations could be utilized as well, such as an “E” block having one or more rigid actuator arm tips or the like that cantilever from a common structure. Movement of the actuator arm assembly 710 is provided by an actuator arm drive assembly, such as a voice coil motor 716 or the like. The voice coil motor 716 is a magnetic assembly that controls the operation of the actuator arm assembly 710 under the direction of control electronics 718.

A load beam or suspension 720 is attached to the free end of each actuator arm 714 and cantilevers therefrom. Typically, the suspension 720 is biased generally toward its corresponding data storage disc 704 by a spring-like force. A slider 722 is disposed at or near the free end of each suspension 720. What is commonly referred to as the read/write head (e.g., transducer) is appropriately mounted as a head unit (not shown) under the slider 722 and is used in disc drive read/write operations. The head unit under the slider 722 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 722 is connected to a preamplifier 726, which is interconnected with the control electronics 718 of the disc drive 700 by a flex cable 728 that is typically mounted on the actuator arm assembly 710. Signals are exchanged between the head unit and its corresponding data storage disc 704 for disc drive read/write operations. In this regard, the voice coil motor 716 is utilized to pivot the actuator arm assembly 710 to simultaneously move the slider 722 along a path 730 and across the corresponding data storage disc 704 to position the head unit at the appropriate position on the data storage disc 704 for disc drive read/write operations.

When the disc drive 700 is not in operation, the actuator arm assembly 710 is pivoted to a “parked position” to dispose each slider 722 generally at or beyond a perimeter of its corresponding data storage disc 704, but in any case in vertically spaced relation to its corresponding data storage disc 704. In this regard, the disc drive 700 includes a ramp assembly 732 that is disposed beyond a perimeter of the data storage disc 704 to both move the corresponding slider 722 vertically away from its corresponding data storage disc 704 and to also exert somewhat of a retaining force on the actuator arm assembly 710.

FIG. 8 is a simplified cross-sectional view of a perpendicular magnetic recording medium 800, which may be used for the data storage disc 704 (FIG. 7). The perpendicular magnetic recording medium 800 is an apparatus including multiple layers established upon a substrate 802. A seed layer 808 is a layer that is established overlying the substrate. A base layer 810 is a layer that is established overlying the seed layer 808. Perpendicular magnetic recording islands 812 are recording areas that are established in the base layer 810 and on the seed layer 808.

The substrate 802 can be fabricated from materials known to those skilled in the art to be useful for magnetic recording media for hard disc storage devices. For example, the substrate 802 may be fabricated from aluminum (Al) coated with a layer of nickel phosphorous (NiP). However, it will be appreciated that the substrate 802 can also be fabricated from other materials such as glass and glass-containing materials, including glass-ceramics. The substrate 802 may have a smooth surface upon which the remaining layers can be deposited.

In a further embodiment, a buffer layer 804 is established overlying the substrate 802, a soft underlayer 806 is established overlying the buffer layer 804, and the seed layer 808 is overlying the soft underlayer 806. The buffer layer 804 can be established from elements such as Tantalum (Ta). The soft underlayer 806 can be established from soft magnetic materials such as CoZrNb, CoZrTa, FeCoB and FeTaC. The soft underlayer 806 can be formed with a high permeability and a low coercivity. For example, in an embodiment the soft underlayer 806 has a coercivity of not greater than about 10 oersteds (Oe) and a magnetic permeability of at least about 50. The soft underlayer 806 may comprise a single soft underlayer or multiple soft underlayers, and may be separated by spacers. If multiple soft underlayers are present, the soft underlayers can be fabricated from the same soft magnetic material or from different soft magnetic materials.

In the embodiment illustrated, the seed layer 808 is disposed on the soft underlayer 806. The seed layer 808 can be established, for example, by physical vapor deposition (PVD) or chemical vapor deposition (CVD) from noble metal materials such as, for example, Ru, Ir, Pd, Pt, Os, Rh, Au, Ag or other alloys. The use of these materials results in desired growth properties of the perpendicular magnetic recording islands 812.

The perpendicular magnetic recording islands 812 as described herein may be formed within the base layer 810 and on the seed layer 808 according to the embodiments of the present invention. The perpendicular magnetic recording islands 812 can be established to have an easy magnetization axis (e.g., the C-axis) that is oriented perpendicular to the surface of the perpendicular magnetic recording medium 800. Useful materials for the perpendicular magnetic recording islands 812 include cobalt-based alloys with a hexagonal close packed (hcp) structure. Cobalt can be alloyed with elements such as chromium (Cr), platinum (Pt), boron (B), niobium (Nb), tungsten (W) and tantalum (Ta).

The perpendicular magnetic recording medium 800 can also include a protective layer (not shown) on top of the perpendicular magnetic recording islands 812 and/or the base layer 810, such as a protective carbon layer, and a lubricant layer disposed over the protective layer. These layers are adapted to reduce damage from the read/write head interactions with the recording medium during start/stop operations.

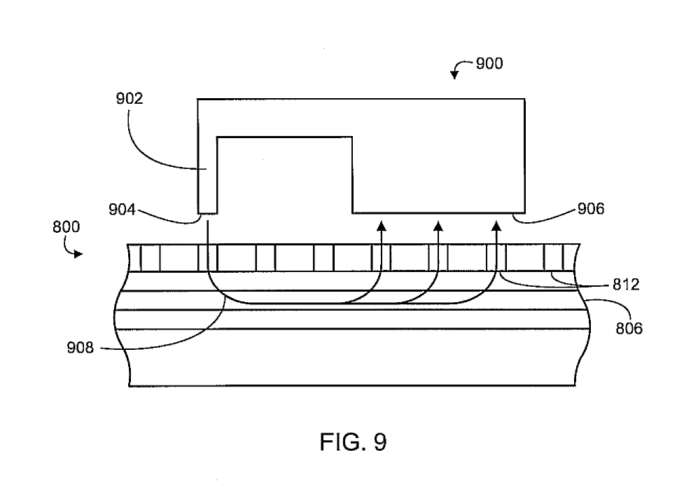

FIG. 9 is a simplified cross-sectional view of a portion of the perpendicular magnetic recording medium 800 with a head unit 900. During the writing process, a perpendicular write head 902 flies or floats above the perpendicular magnetic recording medium 800. The perpendicular write head 902 includes a write pole 904 coupled to an auxiliary pole 906. The arrows shown indicate the path of a magnetic flux 908, which emanates from the write pole 904 of the perpendicular write head 902, entering and passing through at least one perpendicular magnetic recording island 812 in the region below the write pole 904, and entering and traveling within the soft underlayer 806 for a distance. The magnetically soft underlayer 806 serves to guide magnetic flux emanating from the head unit 900 through the recording island 812, and enhances writability. As the magnetic flux 908 travels towards and returns to the auxiliary pole 906, the magnetic flux 908 disperses.

The magnetic flux 908 is concentrated at the write pole 904, and causes the perpendicular magnetic recording island 812 under the write pole 904 to magnetically align according to the input from the write pole 904. As the magnetic flux 908 returns to the auxiliary pole 906 and disperses, the magnetic flux 908 may again encounter one or more perpendicular magnetic recording islands 812. However, the magnetic flux 908 is no longer concentrated and passes through the perpendicular magnetic recording islands 812, without detrimentally affecting the magnetic alignment of the perpendicular magnetic recording islands 812.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method comprising:
moving an imprinter against a surface to be imprinted, wherein said imprinter comprises a main body, an imprinting pattern layer, and a layer of heating material between said main body and the imprinting pattern layer;
supplying energy to said layer of heating material to form features in said surface to be imprinted.

2. The method of claim 1 wherein said surface to be imprinted comprises a resist layer disposed over a substrate.

3. The method of claim 2 wherein said supplying energy to said resist layer further comprises heating said resist layer without substantially altering a temperature of said substrate and said main body.

4. The method of claim 1 wherein:
said layer of heating material is an electrical heating sheet disposed between said main body and an imprinting layer; and
said supplying energy to said layer of heating material comprises electrically heating said electrical heating sheet.

5. The method of claim 1 wherein:
said layer of heating material is an optically absorbing layer disposed between said main body and an imprinting layer; and
said supplying energy to said layer of heating material comprises using a light source to deliver energy to said optically absorbing layer.

6. The method of claim 1 wherein:
said layer of heating material is an optically absorbing resist layer disposed over a substrate; and
said supplying energy to said layer of heating material comprises delivering light energy to said optically absorbing resist layer.

7. The method of claim 1 wherein said surface to be imprinted is a thermal plastic resist layer, and wherein said supplying energy to said thermal plastic resist layer causes said thermal plastic resist layer to reflow.

8. A method of thermal imprint lithography, said method comprising:
pressing together an imprinter and a workpiece, wherein said imprinter comprises a main body and an imprinting layer; and
heating a layer of material disposed between said main body and said workpiece without substantially heating said imprinter and said main body, wherein said heating imprints said workpiece.

9. The method of claim 8 wherein said heating said layer of material disposed between said main body and said workpiece comprises electrically heating said layer of material between said main body and said workpiece.

10. The method of claim 8 wherein said heating said layer of material disposed between said main body and said workpiece comprises optically heating said layer of material between said main body and said workpiece.

11. The method of claim 8 wherein said layer of material disposed between said main body and said workpiece comprises a resist layer, and said workpiece comprises a substrate and said resist layer.

12. The method of claim 8 wherein said heating causes said material disposed between said main body and said workpiece to reflow, and further comprising cooling said material between said main body and said workpiece to a temperature where viscosity of said material between said main body and said workpiece is high.

13. The method of claim 8 wherein said workpiece comprises a substrate, a buffer layer overlying said substrate, a soft underlayer overlying said buffer layer, and a seed layer overlying said soft underlayer.

14. An apparatus comprising:
a main body;
an imprinting layer disposed between said main body and a workpiece, said imprinting layer including a surface with a pattern formed therein; and
a layer of heating material disposed between said main body and said workpiece.

15. The apparatus of claim 14, wherein said layer of heating material comprises an electrical heater for converting electrical energy into thermal energy.

16. The apparatus of claim 15, wherein said layer of heating material is disposed between said main body and said imprinting layer.

17. The apparatus of claim 14, wherein said main body is transparent.

18. The apparatus of claim 14, wherein said layer of heating material comprises an optically heated material.

19. The apparatus of claim 14, wherein said layer of heating material comprises an optically heated resist layer disposed over a substrate.

20. The apparatus of claim 14, wherein said pattern comprises a pattern of sub-micron or nano-dimensioned features.
